(19) United States
(12) Patent Application Publication
(10) Pub. No.: US 2004/0064352 A1
(43) Pub. Date: Apr. 1, 2004

(54) Method and apparatus for administering sports leagues

(76) Inventors: John E. Gordon, Perrysburg, OH (US); Donald A. Monteleone, Bowling Green, OH (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/250,391

(22) PCT Filed: Jan. 4, 2002
(86) PCT No.: PCT/US02/00262

(51) Int. Cl. G06F 17/60

(52) U.S. Cl. 705/8; 705/9; 705/1

(57) ABSTRACT

A method and apparatus (10) for administering sports leagues including the steps of providing a web site (13) for the administration of information related to a sports league and members of the sports league, registering (27) a league administrator and the league members through the web site, receiving external information (28) related to sports play from the league administrator and the league members, processing the external information (43, 48) and generating internal information (44, 49) related to the sports league and the league members, and permitting the league administrator and the league members secured access to the internal information (45, 50).

### CROSS-REFERENCE TO RELATED APPLICATION

This application claims the benefit of U.S. provisional patent application serial No. 60/259,753 filed Jan. 4, 2001.

### BACKGROUND OF THE INVENTION

The present invention relates generally to a method and apparatus for administering amateur sports leagues.

As used herein, the term “sports” refers to athletic and/or mental activities engaged in for recreation. As used herein, the term “sports league” includes a both a single sports event and two or more related sports events played by individual players or teams of players. Amateur sports leagues exist for every individual and team sport. Examples of such sports include but are not limited to: Golf, Baseball, Soccer, Hockey, Bowling, Basketball, Football, Tennis, Volleyball, Swimming, Billiards, Skiing, Sailing, Lacrosse, Fencing, Cross-country, Track, Darts, Bocce, Chess, Cribbage, Bridge, and Euchre. Probably the biggest problem with administering such sports leagues is “record keeping”. Most league administrators spend an average of 2 to 3 hours per week maintaining schedules, entering scores and performance data, calculating results, tracking performance, collecting finances and communicating accurate information to all league members, teams and/or individual participants, in a timely manner.

Currently available are stand-alone programs that were written to work from a single computer to provide a level of organization to the tasks that are the league administrator's responsibility. For example, software programs for bowling leagues are available at the “cdesoftware.com” web site. CDE also provides league web sites on which the league administrators can post standings.

There are many static web sites that post league standings and other information. For example, the “prepsportszone.com” web site displays league standings, news articles and photos about high school sports.

Available on the Internet is the “golfserv.com” web site that mostly focuses on individual scorekeeping allowing a golfer to enter his/her scores to receive performance and handicap reports by e-mail.

Another Internet web site is “eteamz.com” that permits registrants to build web sites for teams, leagues, organizations and individuals. Online registration services include collecting player/team fees and registrant information, creating custom questions, downloading and printing reports, viewing statistics, and group e-mailing.

### SUMMARY OF THE INVENTION

The present invention concerns a method and an apparatus that have the advantages of reducing administration time by 50% to 75% per week, increasing league communication through a secure personalized web site for each league, and allowing league members the ability to enter and access league information from anywhere. Additionally, a main web site will cater to the needs of the individual participant from the standpoint of tracking his/her individual play in multiple leagues or external to league play. Also, the main web site will address the needs of sports centers, event organizers and the participants of these events, providing them a web accessible environment to set up, enter and publish the details and outcome of each event.

The present invention concerns a method and an apparatus for administering sports leagues including the steps of: providing a web site for the administration of information related to a sports league and members of the sports league; registering a league administrator and the league members through the web site; receiving external information related to sports play from the league administrator and the league members; processing the external information and generating internal information related to the sports league and the league members; and permitting the league administrator and the league members secured access to the internal information. The method includes storing the external information and the internal information in a memory, updating the internal information based upon the external information, providing a secure personalized web site for the sports league and permitting access to the internal information only after receiving login information. An apparatus for performing the method includes a server having a plurality of communication ports for receiving the external data and for sending the internal data, a services provider apparatus connected to the server for processing the external information and generating the internal information, and a memory connected to the services provider apparatus for storing the external information and the internal information.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic block diagram of an apparatus incorporating a system according to the present invention;

FIG. 2 is a flow diagram of a method of registering leagues, league members and individuals for use of the system shown in FIG. 1 according to the present invention;

FIG. 3 is a flow diagram of a method of utilizing, the system shown in FIG. 1 according to the present invention; and

FIG. 4 is a schematic block diagram of the modules in the services provider apparatus shown in FIG. 1.

### DESCRIPTION OF THE PREFERRED EMBODIMENT

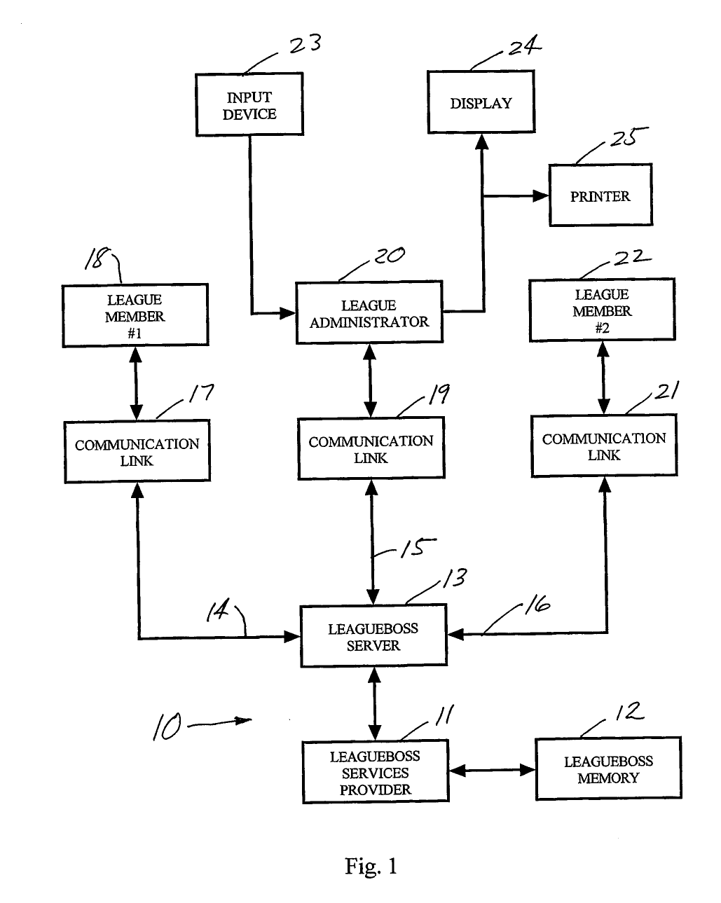

There is shown in FIG. 1 a schematic block diagram of a LeagueBoss™ system 10 in accordance with the present invention. The system 10 solves the biggest problem of administering sports leagues by reducing the amount of time that league administrators spend maintaining schedules, entering data, calculating results, tracking performance, collecting finances and communicating accurate information to all members in a timely manner. The LeagueBoss system 10 reduces administration time through a secure personalized web site for each league, allowing league members the ability to enter and access league information, from anywhere in the world. Additionally, the system provides for the needs of the individual participant from the standpoint of tracking his/her individual play in multiple leagues or external to league play. Further, the system 10 addresses the needs of sports centers, event organizers and the participants in such events, providing them a web accessible environment to set up, enter and publish the details and outcome of each event.

The LeagueBoss system 10 includes a services provider apparatus 11, which can be a programmed computer, connected for data transfer with a memory 12. The memory 12 stores external information received from individual members and league administrators and internal information generated by the services provider apparatus 11. The system 10 also includes a server 13 connected to the services provider apparatus 11 and having multiple communication ports 14, 15 and 16. Although one server and three ports are shown, more than one server and/or more than three ports may be required to handle a large volume of communication. The server 13 maintains a LeagueBoss main web site and controls communication with the services provider apparatus 11.

The port 14 is connected by a communication link 17 to a terminal 18 of a first league member. The communication link 17 is representative of a temporary connection between the terminal 18 and the server 13 established each time that the first league member desires to send and/or receive information. For example, the terminal 18 could be a personal computer and the communication link 17 could be a telephone line, data cable, satellite connection, microwave connection, etc. However, the communication link 17 includes some portion of the Internet network. In a similar manner, the port 15 is connected by a communication link 19 to a terminal 20 of a league administrator and the port 16 is connected by a communication link 21 to a terminal 22 of a second league member. Each of the terminals 18, 20 and 22 can be a personal desktop or laptop computer, a personal digital assistants (PDA), a digital cellular telephone or any device capable of inputting to the server 13 the necessary external information and/or displaying the internal information generated by the services provider apparatus 11.

Typically, the league member and/or league administrator inputs the external information (member name, play date, score, etc.) using a keyboard or keypad associated with the terminal. However, an alternate input device 23 can be used such as a scanner to read score cards or a voice recognition system to accept spoken external information. Typically, the internal information generated by the services provider apparatus 11 is received by the terminal as requested and is presented on a display device 24 and/or printed on a printer 25. The units 23, 24 and 25 are shown connected to the terminal 20 and are representative of the units that can be connected to the terminals 18 and 22 and to any other such terminal.

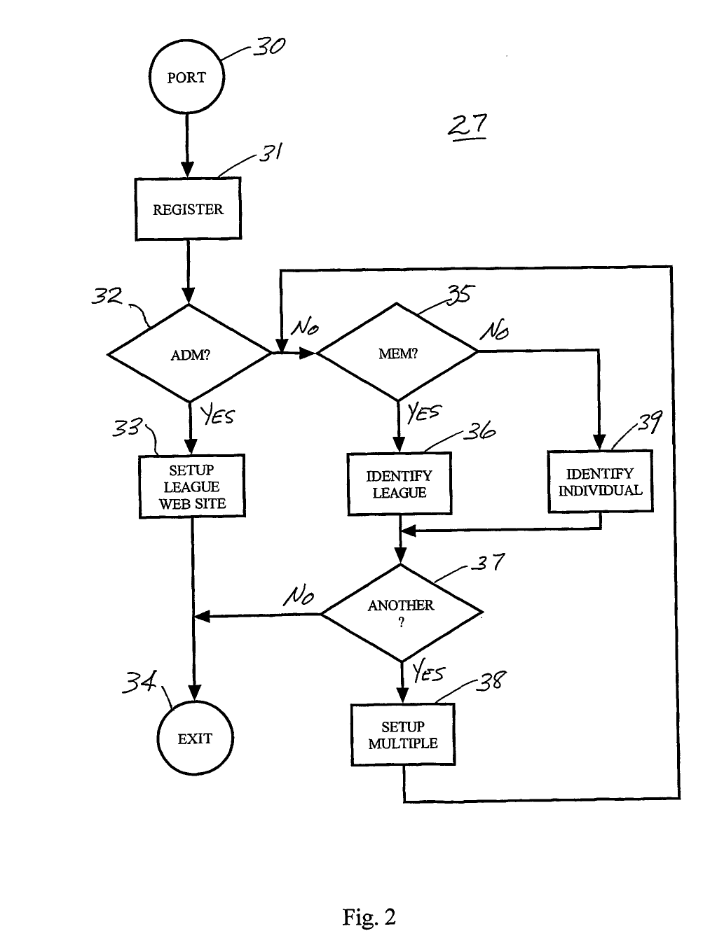

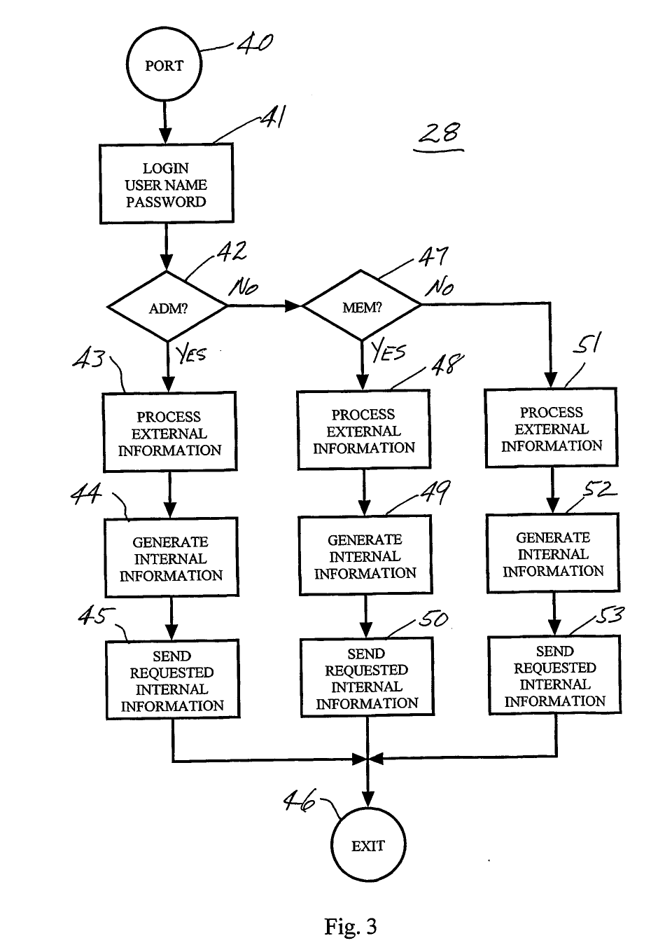

FIG. 2 is a flow diagram of a method 27 of registering leagues, league members and individuals for use of the system 10 according to the present invention. FIG. 3 is a flow diagram of a method 28 of utilizing the system 10 according to the present invention. As shown in FIG. 2, a person desiring to register connects to the system 10 and enters at a “Port” circle 30 representative of the ports 14, 15 and 16 or any similar port connected to the server 13. The method proceeds to a “Register” instruction set 31 wherein the person selects a user name and password and provides any billing information required. Next, an ADM? decision point 32 directs league administrators from a “Yes” branch to a “Setup League Web Site” instruction set 33 for gathering the external information necessary to create the league web site with play tracking and reporting. The method exits from the system 10 at an “Exit” circle 34.

If the person is not a league administrator, the method branches from the decision point 32 at “No” and enters a MEM? Decision point 35 that directs league members to a “Yes” branch and persons having non-league play to a “No” branch. The “Yes” branch leads to an “Identify League” instruction set 36 wherein the person selects an existing league of which he/she is a member. Now the system 10 will permit the person access to information for the identified league. The method then enters an “Another?” decision point 37 wherein a person who is a member of two or more registered leagues, or desires to add non-league play, branches at “Yes” to a “Set Up Multiple” instruction set 38. The method returns to the “Mem?” decision point 35 so that the person can identify a second registered league using the instruction set 36. Now the system 10 will permit the person access to information for both identified leagues. This process is repeated for any number of registered leagues.

A “No” branch from the “Mem?” decision point 35 is used for persons who are not a member of a registered league or league members who also desire to track non-league play. The “No” branch enters an “Identify Individual” instruction set 39 that establishes the play tracking and reporting for non-league play. The method then enters the instruction set 37 to check for the addition of a registered league or different non-league play.

As shown in FIG. 3, a person who is a registered user connects to the system 10 and enters at a “Port” circle 40 representative of the ports 14, 15 and 16 or any similar port connected to the server 13. The method proceeds to a “Login User Name Password” instruction set 41 wherein the person enters his/her registered user name and password. Next, an ADM? decision point 42 directs league administrators from a “Yes” branch to a “Process External Information” instruction set 43 for entering new and/or corrected external information representing the new and/or corrected league play. The method enters a “Generate Internal Information” instruction set 44 wherein the services provider apparatus 11 processes the external information and generates internal information regarding play tracking and reporting. Next, a “Send Requested Internal Information” instruction set 45 causes the services provider apparatus 11 to send to the administrator all requested internal information such as member performance, member standings, play schedules, etc. The method exits from the system 10 at an “Exit” circle 46.

Registered users who are not league administrators exit the “ADM?” decision point 42 at a “No” branch to a “MEM?” decision point 47. A member of at least one league branches from the decision point 47 at “No” to a “Process External Information” instruction set 48 for entering new and/or corrected external information. Typically, the league member cannot change the league internal information stored in the memory 12, but may request or confirm such items as scheduled play times and corrections to performance data. The method enters a “Generate Internal Information” instruction set 49 wherein the services provider apparatus 11 processes the external information and generates internal information regarding play tracking and reporting. Next, a “Send Requested Internal Information” instruction set 50 causes the services provider apparatus 11 to send to the member all requested internal information such as member performance, member standings, play schedules, etc. A member who has registered for any combination of two or more league play and non-league play has access to all the related internal information. The method exits from the system 10 at the “Exit” circle 46.

Registered users who are not league members exit the “MEM?” decision point 47 at a “No” branch to a “Process External Information” instruction set 51 for entering new and/or corrected external information. Typically, the user cannot change the internal information stored in the memory 12, but may request or confirm such items as scheduled play times and corrections to performance data. The method enters a “Generate Internal Information” instruction set 52 wherein the services provider apparatus 11 processes the external information and generates internal information regarding play tracking and reporting. Next, a “Send Requested Internal Information” instruction set 53 causes the services provider apparatus 11 to send to the user all requested internal information such as performance, play schedules, etc. A user who has registered for any combination of two or more non-league play has access to all the related internal information. The method exits from the system 10 at the “Exit” circle 46.

Golf is an example of a sport that has both league and non-league play. Golf leads the sports industry for revenue potential. There are over 17,000 golf courses in the United States. Golf is one of the fastest growing leisure sports in the U.S., and is expected to grow at a pace of 4% per year over the next five years. The LeagueBoss system 10 generates revenues through golf league fees, golfers individual scorekeeping fees, private golf tournament fees, golf outing fees, golf club (USGA HCP index), and advertising fees for the web site. The LeagueBoss system 10 is designed to be scalable to millions of users. It is a one-stop superset of features for individuals, teams and events, which allows each group their own secure on-line software. Each sports league has ability to push and pull information with anyone in the league or event. Every user has access to the internal information and security permits any user to enter external information from anywhere in the world.

The LeagueBoss system 10 is an Internet-based service for the tracking of sports play performance for any purpose. This service is a welcome relief to all the hassles experienced by anyone who has had to track statistics for any sporting event. For example, it can be utilized by any golf course, golf league, golf outing administrator or individual golfer—anywhere in the world. This service is configurable for each usage allowing for flexibility in tracking handicaps (USGA, League Rules, etc.) for course/league members and individuals, various popular golf games (skins, bingo-bango-bongo, longest drive, putt, etc.), collecting and reporting results of outings. Custom configuration is paramount for each course, league and hole (e.g. 10 max strokes per hole, double par max, one stroke max on par 3, etc.) The service is designed to handle match, stroke, team, scramble or individual play. Results can be printed, viewed on screen or published to a web site in tabular and graphical format. Certificates for winners can be printed.

For golf courses without a current web site, the LeagueBoss system 10 offers a wizard-driven template for golf course web-site development that would include directions to the course, links to local weather, lodging, dining and nightlife, hole by hole pictures, descriptions, current conditions and tips, course and clubhouse facilities/menus/golf apparel and accessories, on line tee time registration, secure e-commerce payment of greens fees, etc. Custom web site development also is available.

The LeagueBoss system 10 incorporates technologies such as scanning of scorecards, printing of custom score cards for outings and leagues, telemetry of cart based electronic scoring, of handheld Palm O/S based download of course data and upload of scores.

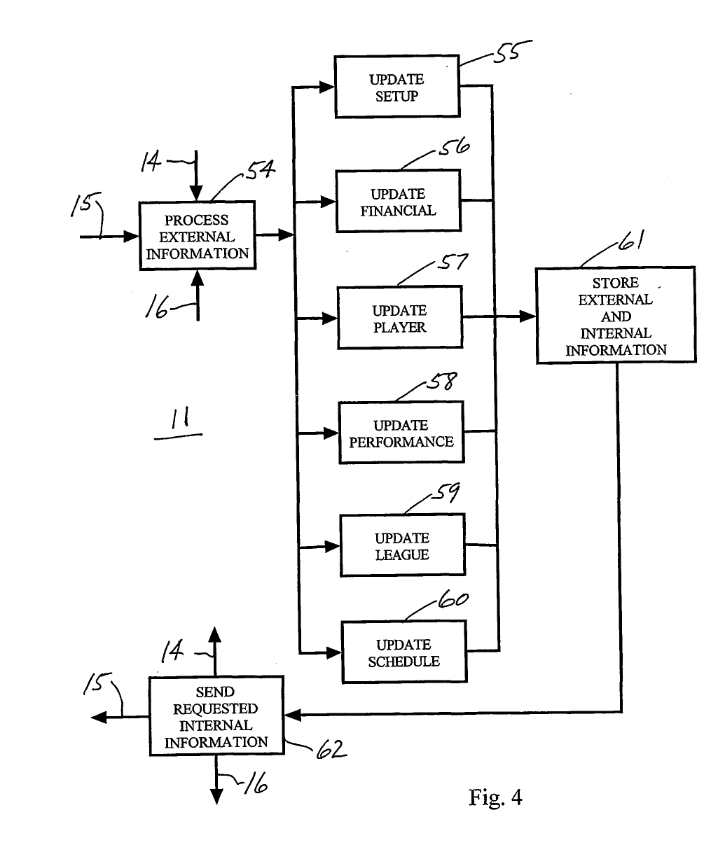

FIG. 4 is a schematic block diagram showing modules of the services provider apparatus 11. The ports 14, 15 and 16 are connected to inputs of a process external information means module 54 that processes all external information received from users of the system 10 such as league administrators, league members and individual players. An output of the module 54 is connected to an input of an update setup means module 55 that performs the steps of the registration method shown in FIG. 2. The output of the module 54 is also connected to an input of each of an update financial means module 56, an update player means module 57, an update performance means module 58, an update league means module 59, and an update schedule means module 60. The financial module 56 updates billing and payment of system use charges and play-related fees and dues. The player module 57 updates player-related information such as individual scores and schedules. The performance module 58 updates player and team performance statistics such as golf handicaps and baseball batting averages. The league module 59 updates league standings and associated statistics. The schedule module 60 updates schedules for players and teams.

An output of each of the modules 55 through 60 is connected to an input of a store external and internal information means module 61. The module 61 communicates the received external information and the generated internal information to the memory 12. An output of the store module 61 is connected to an input of a send requested internal information means module 62 having outputs connected to the ports 14, 15 and 16. The module 62 responds to information requests entered by a user to communicate the corresponding internal information.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A method for administering sports leagues comprising the steps of:
a. providing a web site (13) for the administration of information related to a sports league and members of the sports league;
b. registering (27).a league administrator and the league members through the web site;
c. receiving external information (28) related to sports play from the league administrator and the league members;
d. processing the external information (43, 48) and generating internal information (44, 49) related to the sports league and the league members; and
e. permitting the league administrator and the league members secured access to the internal information (45, 50).

2. The method according to claim 1 including a step of storing the external information and the internal information in a memory (12, 61).

3. The method according to claim 1 wherein said step d. includes updating the internal information (55, 56, 57, 58, 59, 60) based upon the external information.

4. The method according to claim 1 wherein said step b. includes providing a secure personalized web site for the sports league (33) and said step e. is performed only after receiving login information (41).

5. The method according to claim 1 including performing said steps b. through e. for a first sports league and a second sports league having at least one of the league members in common.

6. The method according to claim 1 including the steps of:
f. registering (27, 39) at least one of the league members through the web site for non-league sports play;
g. receiving external information (28) related to the non-league sports play from the at least one league member;
h. processing the non-league external information (51) and generating non-league internal information (52) related to the at least one league member; and
i. permitting the at least one league member secured access to the non-league internal information (53).

7. The method according to claim 1 wherein the sports league is for one of Golf, Bowling, Baseball, Soccer, Hockey, Basketball, Football, Tennis, Volleyball, Swimming, Billiards, Skiing, Lacrosse, Fencing, Cross-country, Track, Bocce, Chess, Cribbage, Bridge and Euchre.

8. An apparatus for performing the method according to claim 1 including a server (13) having a plurality of communication ports (14, 15, 16) for receiving the external data and for sending the internal data.

9. The apparatus according to claim 8 including a services provider apparatus (11) connected to the server (13) for performing the step d.

10. The apparatus according to claim 9 including a memory (12) connected to the services provider apparatus (11) for storing the external information and the internal information.
